(19) United States
(12) Patent Application Publication
(10) Pub. No.: US 2009/0149051 A1
(43) Pub. Date: Jun. 11, 2009

(54) MOUNTING APPARATUS FOR PLUG OF SIGNAL WIRE

(75) Inventor: HU-FEI DENG, Shenzhen (CN)

Correspondence Address: PCE INDUSTRY, INC.;ATT. Steven Reiss, 458 E. LAMBERT ROAD, FULLERTON, CA, 92835, US

(73) Assignees: HONG FU JIN PRECISION INDUSTRY (ShenZhen) CO., LTD., Shenzhen City (TW); HON HAI PRECISION INDUSTRY CO., LTD., Tu-Cheng (TW)

(21) Appl. No.: 11/967,053

(22) Filed: Dec. 29, 2007

(30) Foreign Application Priority Data
Dec. 6, 2007 (CN) 200710202875.X

(51) Int. Cl. H01R 13/625

(52) U.S. Cl. 439/345

(57) ABSTRACT

A mounting apparatus for securely fixing a plug to a socket. The socket includes two opposite sidewalls. The mounting apparatus includes a pair of securing means movably mounted to the corresponding sidewalls of the socket for clamping the plug.

### BACKGROUND

1. Field of the Invention

The present invention relates to mounting apparatuses, and especially to a mounting apparatus for securely fixing a plug of a signal wire.

2. Description of Related Art

Nowadays, SATA hard disk drives (HDDs) are widely used in computers, and SATA plugs are also designed in motherboards of the computers for connecting to the SATA HDDs. However, the plug of the SATA HDD is easy to depart from the motherboard when the computer is moved.

What is desired, therefore, is a mounting apparatus which securely fixes the plug of a signal wire to a socket.

### SUMMARY

An exemplary mounting apparatus for securely fixing a plug to a socket. The socket includes two opposite sidewalls. The mounting apparatus includes a pair of securing means movably mounted to the corresponding sidewalls of the socket for clamping the plug.

Other advantages and novel features will become more apparent from the following detailed description when taken in conjunction with the accompanying drawings, in which:

### BRIEF DESCRIPTION OF THE DRAWINGS

FIG. 1 is an isometric view of a mounting apparatus in accordance with a first embodiment of the present invention together with a signal wire and a socket; and

FIG. 2 is an isometric view of a mounting apparatus in accordance with a second embodiment of the present invention together with a signal wire and a socket; and

FIG. 3 is an isometric view of a mounting apparatus in accordance with a third embodiment of the present invention together with a signal wire and a socket.

### DETAILED DESCRIPTION

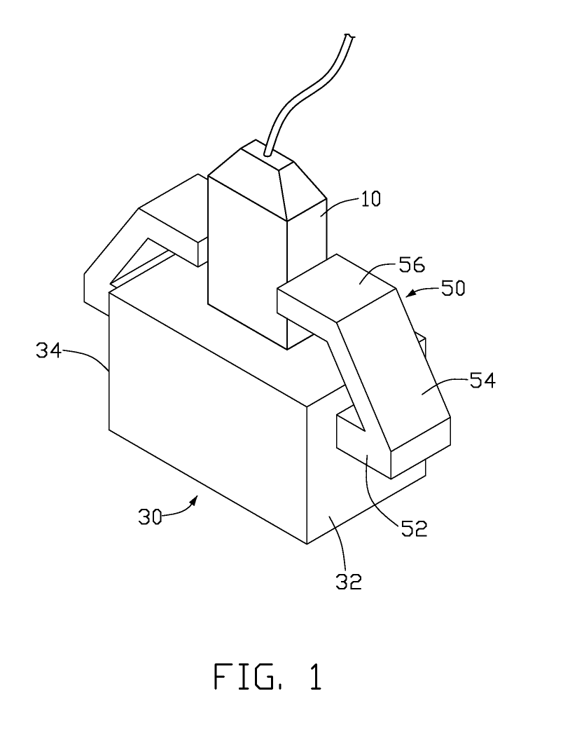

Referring to FIG. 1, a mounting apparatus in accordance with a first embodiment of the present invention is provided for fixing a plug 10 to a socket 30. The mounting apparatus includes a pair of opposite elastic generally C-shaped hooks 50 respectively fixed to the socket 30 for clamping the plug 10, and the hooks 50 are an exemplary securing means according to this embodiment.

The socket 30 includes a first sidewall 32 and a second sidewall 34 parallel to the first sidewall 32.

Each hook 50 includes a connecting portion 52 extending from the corresponding first sidewall 32 or the second sidewall 34, a bending portion 54 slantingly extending from a free end of the connecting portion 52 and over an upper wall of the socket 30, and a latching portion 56 extending from a free end of the bending portion 54 and parallel with the upper wall towards the opposite hook 50.

To use the mounting apparatus, the bending portions 54 of the hooks 50 are pulled outward to depart away from each other, and the plug 10 is inserted into the socket 30. Then releasing the bending portion 54, the bending portions 54 are restored, and respectively drive the latching portions 56 of the hooks 50 to clamp the plug 10 of the signal wire.

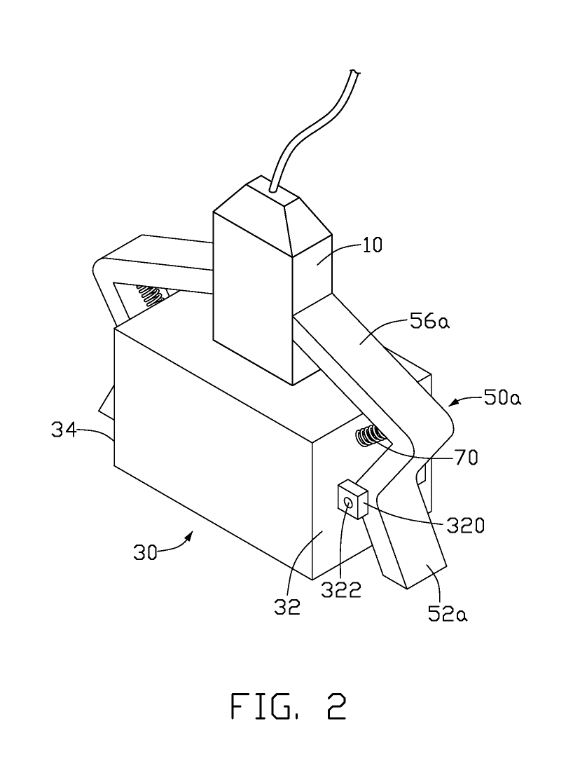

Referring to FIG. 2, a mounting apparatus in accordance with a second embodiment of the present invention is provided for fixing the plug 10 to the socket 30. The mounting apparatus includes two hooks 50a for securing the plug 10, and two elastic members, and the hooks 50a are the exemplary securing means according to this embodiment. In this embodiment each elastic member is a spring 70.

Two horizontally-spaced positioning blocks 320 each defining a through hole 322 therein respectively extend from the first sidewall 32 and the second sidewall 34.

Each hook 50a includes a generally L-shaped latching portion 56a. The latching portion 56a includes a first section slantingly extending toward the opposite latching portion 56a and over the upper wall of the socket 30 and a second section. An operating portion 52a slanting downward from a end of the second section of the latching portion 56a. Two shafts respectively extend from two sides of a joint between the latching portion 56a and the operating portion 52a.

To assemble the mounting apparatus, the shafts of each hook 50a are pivotably engaged in the through holes 322 of the corresponding positioning blocks 320. One end of each spring 70 is fixed to the first sidewall 32 or the second sidewall 34, and the other end of each spring 70 is fixed adjacent a turning portion of the latching portion 56a of corresponding hook 50a.

To use the mounting apparatus, the operating portions 52a of the hooks 50a are pressed to urge the latching portions 56a of the hooks 50a to move away from each other, and the springs 70 are respectively stretched out with the hooks 50a. The plug 10 is inserted into the socket 30, then the operating portions 52a are released, and the springs 70 are respectively restored to clamp the plug 10.

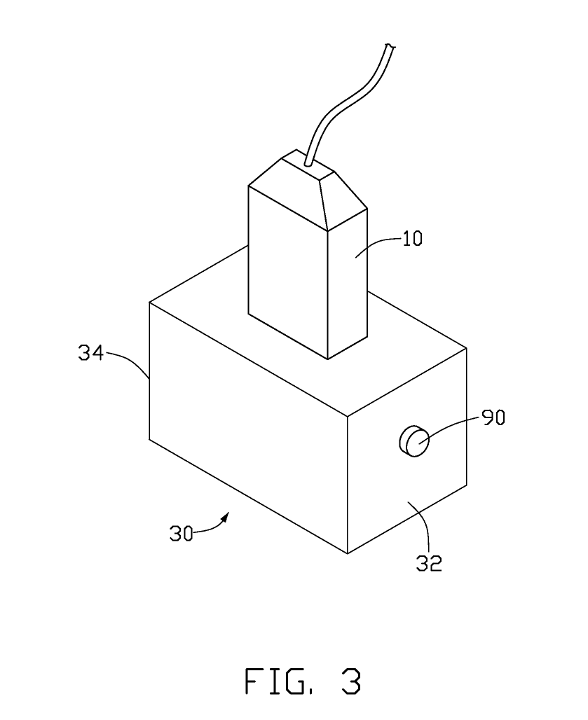

Referring to FIG. 3, a mounting apparatus in accordance with a third embodiment of the present invention is provided for fixing the plug to the socket 30. The mounting apparatus includes two bolts 90 for securing the plug 10, and the bolts 90 are the exemplary securing means according to this embodiment.

The first sidewall 32 and the second sidewall 34 respectively define a fastener hole (not shown) therein.

To use the mounting apparatus, the plug 10 is inserted into the socket 30, and the two bolts 90 are respectively screwed in the fastener holes for resistingly engaging the plug 10, thus the plug 10 is fixed in the socket 30.

It is believed that the present embodiments and theirs advantages will be understood from the foregoing description, and it will be apparent that various changes may be made thereto without departing from the spirit and scope of the invention or sacrificing all of its material advantages, the examples hereinbefore described merely being preferred or exemplary embodiments.

1. A mounting apparatus assembly comprising:
a plug comprising a pair of opposite sidewalls;
a socket, the socket comprising a pair of opposite sidewalls, a fastener hole transversely passing through each of the socket sidewalls in a first direction generally perpendicular to a second direction along which the plug is inserted into the socket, wherein the plug is capable of being engagably received in the socket with the outer surface of the plug sidewalls abutting against the inner surface of the socket sidewalls; and
two bolts;
wherein the bolts are capable of engaging into and extending through the fastener holes of the socket sidewalls for clamping the outer surface of the plug sidewalls.

2-7. (canceled)
